(19) United States
(12) Patent Application Publication
(10) Pub. No.: US 2023/0228135 A1
(43) Pub. Date: Jul. 20, 2023

(54) DOOR ARRANGEMENT FOR A WIND TURBINE, DOOR LOCKING DEVICE AND WIND TURBINE

(71) Applicant: Siemens Gamesa Renewable Energy Innovation & Technology S.L., Sarriguren(Navarra) (ES)

(72) Inventors: Michael Jacobs, Oviedo, FL (US); Nan YU, Oviedo, FL (US)

(21) Appl. No.: 18/095,884

(22) Filed: Jan. 11, 2023

(30) Foreign Application Priority Data
Jan. 20, 2022 (EP) 22-382035.8

(51) Int. Cl. E05C 17/44; F03D 80/00

(52) U.S. Cl. CPC E05C 17/44; F03D 80/00

(57) ABSTRACT

A door arrangement for a wind turbine includes a door with an outer side and an inner side and a door locking device for locking and unlocking the closed door by coupling and decoupling the closed door with a stationary component of the door arrangement of the wind turbine, wherein the door locking device includes a central component, an attachment and a connector, wherein the central component is attached to the stationary component by the attachment and connectable and disconnectable with the door by the connector for locking and unlocking the door by a person being at the outer side, wherein the attachment is manually releasable by a person being at the inner side for disconnecting the central component from the stationary component to unlock the door without tools.

### CROSS-REFERENCE TO RELATED APPLICATIONS

This application claims priority to EP Application No.22382035.8, having a filing date of Jan. 20, 2022, the entire contents of which are hereby incorporated by reference.

### FIELD OF TECHNOLOGY

The following relates to a door arrangement for a wind turbine, comprising a door with an outer side and an inner side and a door locking device for locking and unlocking the closed door by coupling and decoupling the closed door with a stationary component of the door arrangement or the wind turbine.

### BACKGROUND

Doors of wind turbines are provided to protect the interior of the wind turbine from disadvantageous weather conditions like humidity and/or extreme temperatures. Mostly, such doors are lockable to ensure that unauthorized persons cannot enter the wind turbine. However, persons who are currently in the interior of the wind turbine e.g., for maintenance work might have to leave the wind turbine. Particularly in case of a fire alarm or another threatening situation it is necessary that staff working within the wind turbine can leave the interior as quick as possible. This might be problematic if the door is currently locked. Another problem regarding lockable doors of wind turbines is that persons might be locked in the wind turbine accidentally.

### SUMMARY

Hence, An aspect relates to provide an enhanced concept regarding lockable doors for wind turbines.

To solve this problem by means of embodiments of the present invention, a door arrangement as initially described is characterized in that the door locking device comprises a central component, an attaching means and a connecting means, wherein the central component is attached to the stationary component by the attaching means and connectable and disconnectable with the door by the connecting means for locking and unlocking the door by a person being at the outer side, wherein the attaching means is manually releasable by a person being at the inner side for disconnecting the central component from the stationary component to unlock the door without tools.

Embodiments of the present invention are based on the idea that the central component constitutes two mechanical connections, namely a first connection connecting the central component and the door and a second connection connecting the central component and the stationary component. Under normal conditions, the connection between the central component and the stationary component is closed. However, this connection can be opened by the person being at the inner side of the door or, in other words, within the interior of the wind turbine by hand without using any kind of tool to manually unlock the door and to be able to escape from the wind turbine in case of an emergency or in case the person has been accidentally locked in.

It is essential for embodiments of the present invention that the attaching means can be manually released or opened by the person being at the inner side. The word “manually” means that the attaching means or the connection between the central component and the stationary component can be released or opened by hand only, i.e., by just using the fingers without any mechanical tools like screw drivers, wrenches, crowbars or the like.

The door can be or comprise a door plate. The door can consist of metal and/or wood and/or plastic or another suitable material. The door can be mounted at a tower of the wind turbine, particularly on the stationary component. Being in the closed position, i.e., being in the state covering an entrance hole of the wind turbine, the door is lockable. In the locked state and from the outer side, the door cannot be opened without a respective key or other entrance means for locking and unlocking the door.

Particularly, the door is a swing door which can be pivoted around a, particularly vertical, axis for bringing it from the open into the closed position and vice versa. In this embodiment, the door is held by hinges which are arranged on the door plate. Alternatively, the door can be a sliding door which is movable along a, particularly horizontal, axis. In this embodiment, the door can be held by and guided on at least one sliding rail, which can be attached to the stationary component.

The stationary component can be a, particularly rectangular, door frame which is fitted into the entrance opening of the tower of the wind turbine, particularly by means of concrete or other suitable filling materials. Alternatively, it is possible that the stationary component is not a separate element but a part of a wall or the tower of the wind turbine surrounding the door or the entrance opening, respectively.

The attaching means can comprise a handling section which the person being at the inner side can grasp by fingers for disconnecting the central component from the stationary component. Hence, the person being at the inner side is able to disconnect the central component and the stationary component just by releasing the attaching means with the help of the handling section. The handling section can be a clamp, a hand wheel, a lever, a knurled knob, a star knob or another manually manipulatable means. Hence, manually disconnecting the central component from the stationary component can be done by tilting the clamp or turning or rotating the hand wheel or lever or the like.

The central component can comprise a plate and a receiving element, wherein the receiving element is attached to the plate and the plate is attached to the stationary component by the attaching means, wherein the receiving element is adapted to receive the connecting means for connecting the central component with the door. The receiving element can be attached to the plate by screws, gluing, welding or the like. The plate and/or the receiving element can consist of metal, particularly of steel, or any other suitable material.

The attaching means can be a or can comprise at least one knob stud which extends through the plate and which is manually unscrewable from a threaded hole of the stationary component for disconnecting the central component from the stationary component to manually unlock the door by the person being at the inner side. The knob stud consists of a threaded bolt with a particularly knurled and/or star-shaped, knob on the one end and which can be screwed into the threaded hole of the stationary component with its other end. Hence, the bolt comprises an external screw thread and the threaded hole comprises an internal screw thread which fit to each other. The plate comprises a hole which has the same diameter as or a larger diameter than the external screw thread of the bolt of the knob stud.

In an embodiment, the attaching means is or comprises three knob studs extending through the plate and being manually unscrewable from a threaded hole of the stationary component each, wherein the three threaded holes are arranged triangularly to each other. Using three knob studs with three threaded holes means that the central component is attached to the stationary component at three points, wherein, if these points are arranged at the three corners of a triangle, no movement or clearance of the central component occurs, when the three knob studs are tightened carefully.

The material and the dimensions of the knob studs can be such that, when all three knob studs are hand-tightened, they collectively provide a clamping force, i.e., a force pressing the plate or central component, respectively, against the stationary component, which is between 5 and 30 kN, particularly 15 kN. This force is large enough to keep the central component in place during a normal operational state.

In an alternative embodiment, as well the central component as an attaching plate, which is attached to the stationary component, comprise a lug, wherein the attaching means is or comprises a pin which extends through the lugs and which can be manually pulled out from the lugs for disconnecting the central component from the stationary component to manually unlock the door by the person being at the inner side. For a better handling and to be able to easily remove the pin from the lugs, the pin can comprise a pin head which additionally can avoid that the pin falls down through the lugs. The longitudinal directions of bores of the lugs are in line which each other to allow the pin to be inserted into the lugs.

The connecting means can be or can comprise at least one threaded bolt which extends through the door and which is unscrewable from a threaded hole of the receiving element for disconnecting the central component from the door to unlock the door by the person being at the outer side. In contrast to the attaching means, the connecting means cannot be unscrewed manually but only with the help of a certain tool.

The receiving element can be a particularly metallic, solid and block-like component comprising the threaded hole. The threaded bolt comprises an external screw thread and the threaded hole of the receiving element an internal screw thread which fit to each other. The door comprises a hole with a diameter which is equal to or larger than the outer diameter of the external screw thread of the threaded bolt.

Referring to the locked state of the door, a screw head of the threaded bolt can hold the door in position. The screw head can be located within a counterbore hole on the outer side of the door or within a supporting element which is attached to the outer side.

The threaded bolt can be unscrewable from and screwable into the threaded hole of the central component with a hex wrench or a wrench comprising a nut. The threaded bolt can be a security bolt which can be unscrewed with special tools only. Respective security systems of screwing connections which cannot be opened by common tools are known and provided by manufacturers like, e.g., McGard.

To achieve embodiments of the present invention, a door locking device for locking an unlocking a closed door with an outer side and an inner side by coupling and decoupling the door with a stationary component is provided, wherein the door locking device comprises a central component, an attaching means and a connecting means, wherein the attaching means is adapted to attach the central component to the stationary component, wherein the connecting means is adapted to connect and disconnect the central component with the door for locking and unlocking the door by a person being at the outer side, wherein the attaching means comprises a handling section which allows the attaching means to be manually released by a person being at the inner side for disconnecting the central component from the stationary component to unlock the door without tools. All advantages, features and aspects explained above with respect to the door arrangement according to embodiments of the present invention also apply to the door locking device according to embodiments of the present invention and vice versa.

The attaching means of the door locking device can comprise a handling section which the person being at the inner side can grasp by the fingers for disconnecting the central component from the stationary component, wherein the handling section is particularly a knurled knob or a star knob.

Embodiments of the present invention are further achieved by a wind turbine, comprising at least one door arrangement according to the description above and/or at least one door locking device according to the preceding section of the description. All advantages, features and aspects which are explained with respect to the door arrangement according to embodiments of the present invention and to the locking device according to embodiments of the present invention also apply to the wind turbine according to embodiments of the present invention and vice versa.

The door arrangement constitutes an entrance door on the bottom of a tower of the wind turbine. The entrance door allows persons to enter the wind turbine from the outside. The tower of the wind turbine can be made of concrete and/or metal or other suitable materials.

### BRIEF DESCRIPTION

Some of the embodiments will be described in detail, with reference to the following figures, wherein like designations denote like members, wherein:

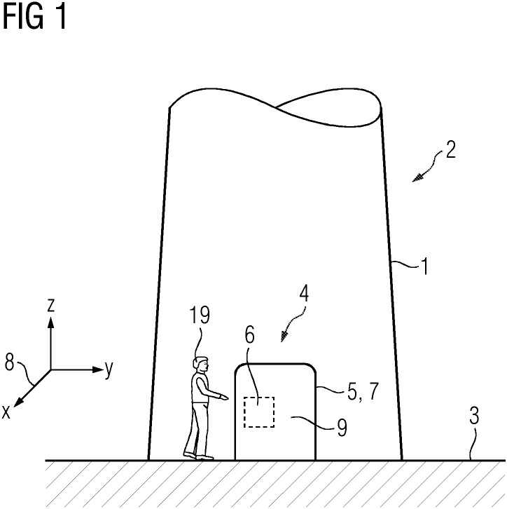

FIG. 1 shows a bottom section of a tower of an embodiment of a wind turbine according to the present invention;

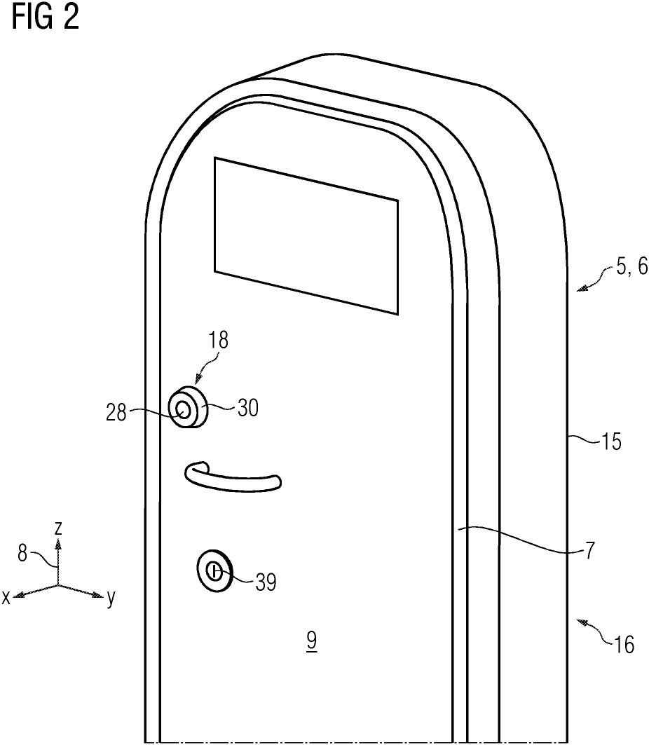

FIG. 2 shows a view on an outer side of a door of an embodiment of a door arrangement according to the present invention of the wind turbine of FIG. 1;

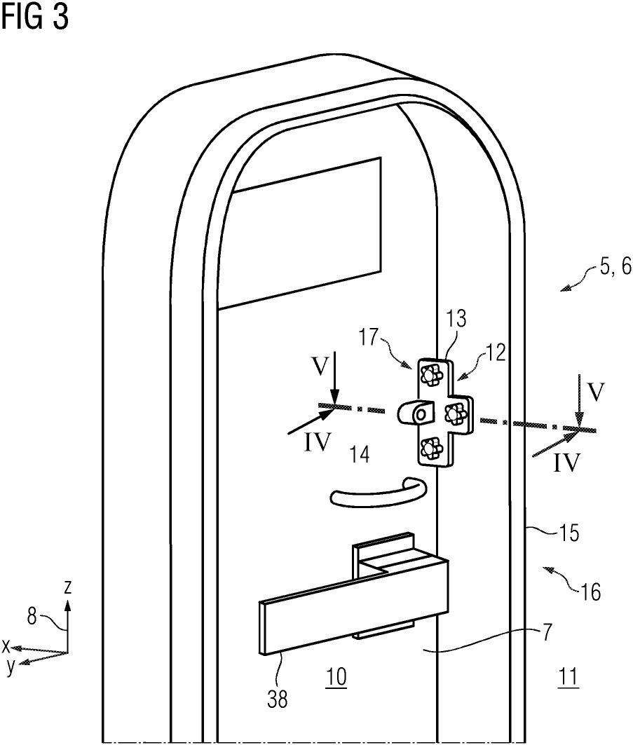

FIG. 3 shows a view on an inner side of the door of the door arrangement of the wind turbine of FIG. 1;

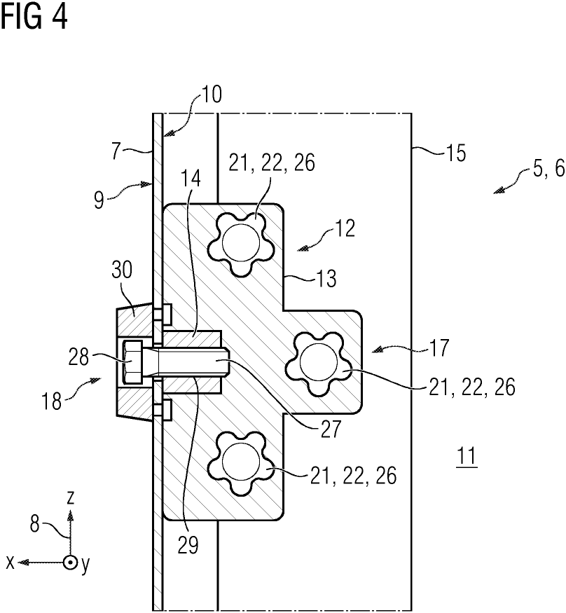

FIG. 4 shows a vertical cut through the door arrangement along the line IV-IV of FIG. 3;

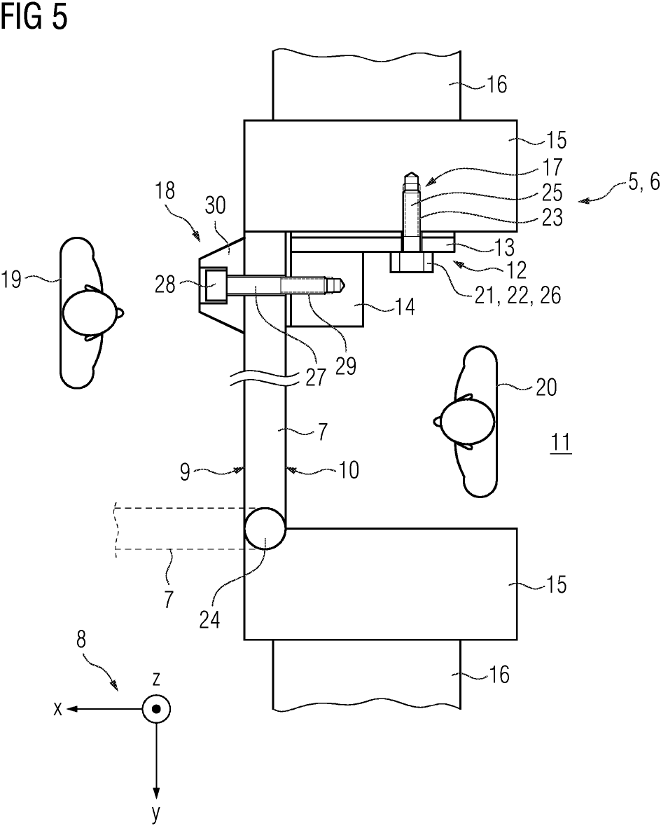

FIG. 5 shows a horizontal cut through the door arrangement along the line V-V of FIG. 3;

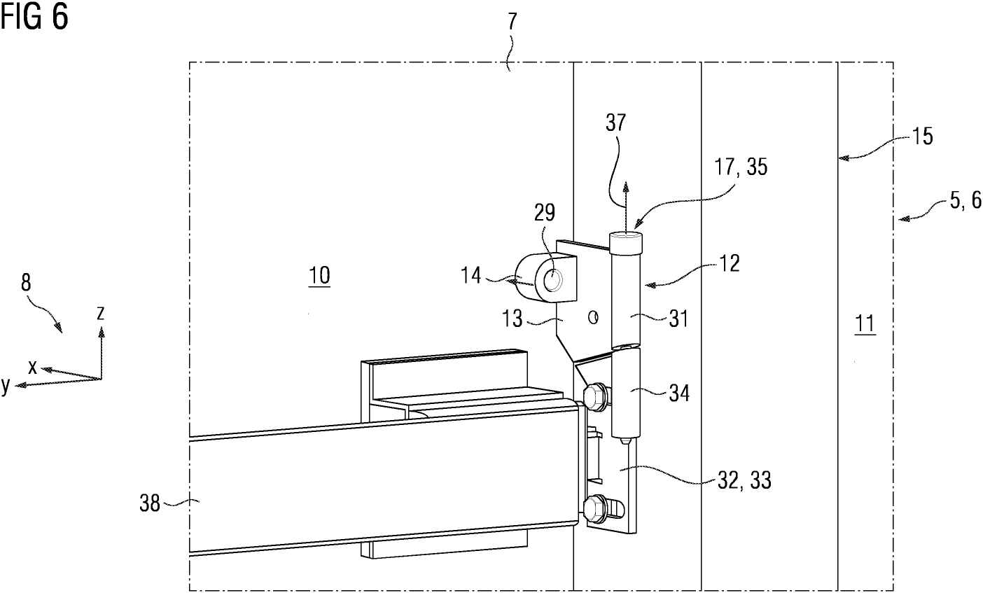

FIG. 6 shows a view on an inner side of a door of another possible embodiment of a door arrangement of the wind turbine of FIG. 1; and

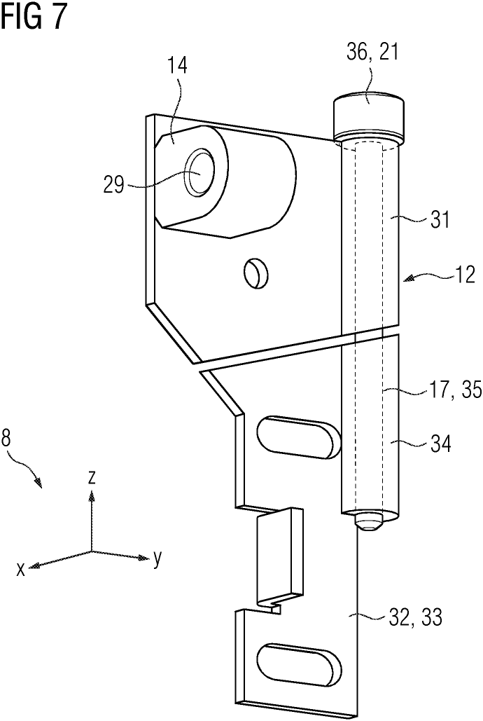

FIG. 7 shows a close-up view of the central component and a bottom bracket of the door arrangement of FIG. 6.

### DETAILED DESCRIPTION

FIG. 1 shows a bottom section of a tower 1 of a wind turbine 2 according to embodiments of the present invention, which is located on a ground 3. The tower 1 comprises an entrance door 4 which is realised by means of a door arrangement 5 according to embodiments of the present invention with a locking device 6 according to embodiments of the present invention.

Details regarding a specific embodiment of the door arrangement 5 and the door locking device 6 are explained in reference to FIGS. 2 to 5. The door arrangement 5 comprises a plate-like door 7 which can be pivoted from an open into a closed position and vice versa by help of hinges 24 (see FIG. 5). While all figures show the door 7 in the closed position, the dashed lines in FIG. 5 indicate the door 7 in the open position. Regarding the closed position, the door 7 comprises an outer side 9 facing the environment and an inner side 10 facing an interior 11 of the wind turbine 2.

For a better orientation, all figures show a coordinate system 8, wherein the x-axis points perpendicular away from the closed door 7, the y-axis runs horizontally within the plane of the closed door and the z-axis points vertically upwards.

As can be seen particularly from FIGS. 3 to 5, the door locking device 6 of the door arrangement 5 comprises a central component 12, which is used for locking and unlocking the closed door 7. The central component 12 comprises a metallic plate 13 and a metallic, block-like and solid receiving element 14 which is attached to the plate 13 by welding.

The central component 12 provides two releasable mechanical connections, namely a first connection connecting the central component 12 and the door 7 and a second connection connecting the central component 12 and a stationary component 15. The stationary component 15 is a door frame which fits into a respective opening of a concrete wall 16 of the tower 1. Alternatively, the stationary component 15 is the wall 16 itself.

Regarding the first connection, the central component 12 is connectable and disconnectable with the door 7 by the connecting means or connector 18. In a normal operational state, connecting and disconnecting the first connection corresponds to locking and unlocking the door 7.

Regarding the second connection, the central component 12 is attached to the stationary component 15 of the door arrangement 5 by an attaching means or attachment 17. In the normal operational state, the second connection or the attaching means or attachment 17, respectively, is in a closed state. However, the attaching means or attachment 17 can also be released to unlock the door 7, particularly in emergency situations.

In the following, the aspects regarding the attaching means 17, the connecting means 18 and the functional principle of the one door locking device 6 are disclosed in detail. Assuming that the locking device 6 is in the normal operational state, i.e., that the central component 12 is connected with the stationary component 15 by the attaching means 17, a person 19 being at the outer side 9 of the door 7 (see FIGS. 1 and 5) can lock the door 7 by connecting it with the central component 12 using the connecting means 18.

Independent from this, the attaching means 17 is manually releasable by a person 20 being at the inner side 10 of the door 7. Thus, the person 20 at the inner side 10 is able to open the connection between the central component 12 and the stationary component 15 just by hand. Regarding the manual opening of the attaching means 17, this component comprises a handling section 21 which the person 20 being at the inner side 10 can grasp by the fingers for disconnecting the central component 12 from the stationary component 15 to unlock the door 7 without tools.

Although the connecting means 18 can be opened just from the outer side 20, the attaching means 17 allows to manually unlock the door 7 from the inner side 10 or the interior 11 of the wind turbine 2. This is advantageous, particularly in the case of a fire alarm or if the person 20 has been accidentally locked into the wind turbine 2.

As shown in FIGS. 4 and 5, the attaching means 17 comprises three knob studs 22 which extend through the plate 13 and which are manually unscrewable from a threaded hole 23 of the stationary component 15 each. Each of the knob studs 22 comprises a threaded bolt 25 with an external screw thread which fits an internal screw thread of the threaded hole 23 of the stationary component 15. The plate 13 comprises a hole, wherein the bolt 25 runs through this hole. The knob stud 22 furthermore comprises a, particularly knurled, star knob 26, which constitutes the handling section 21. The threaded holes 23 are arranged triangularly to each other at the stationary component 15 (see FIG. 4). If all three knob studs 22 are tightened by hand properly, they provide a clamping force of approximately 15 kN which presses the plate 13 towards the stationary component 15.

Referring particularly to FIGS. 4 and 5, the connecting means 18 is a threaded bolt 27 with a screw head 28. The threaded bolt 27 extends through the door 7 and, if the door 7 is locked, screwed into a threaded hole 29 of the receiving element 14. The threaded bolt 27 comprises an external screw thread and the threaded hole 29 an internal screw thread which fit to each other. Referring to the locked state of the door 7 again, the screw head 28 holds the door 7 in position and is located within a counterbore hole of a conical supporting element 30 which is attached on the outer side 9 of the door 7. The threaded bolt 27 is screwed into the threaded hole 29 of the receiving element 14.

The person 19 being at the outer side 9 of the door 7 can lock/unlock the door 7 by screwing/unscrewing the threaded bolt 27 into the threaded hole 29 by a tool. The tool can be a hex-wrench which can be inserted into a respective hex hole of the screw head 28. The tool comprises a special nut, which only fits to the respective screw head 28 to provide a security system. In this security system, the door 7 can be unlocked by the respective special tool or nut only.

FIGS. 6 and 7 show another possible embodiment of the door locking device 6. In this embodiment, the same connecting means 18 as in the embodiment shown in FIGS. 2 to 5 is provided. The central component 12 comprises the plate 13, the receiving element 14 and, in contrast to the previous embodiment, a cylindrical lug 31. An attaching plate 32 is attached to the stationary component 15. Particularly, the attaching plate 32 comprises a plate 33 for screwing the attaching plate 32 on the stationary component 15. The attaching plate 32 furthermore comprises a cylindrical lug 34, wherein borings through the lugs 31, 34 are arranged coaxially.

The attaching means 17 is a pin 35 which extends through the lugs 31, 34. The pin 35 comprises a pin head 36 to avoid that the pin 35 falls through the lugs 31, 34. The attaching means 12 or the pin 35, respectively, can be released by the person 20 being at the inner side 10 to unlock the door 7 without tools just by pulling the pin 35 out of the lugs 31, 34 with the hand, which is indicated by the arrow 37 in FIG. 6. Hence, in this embodiment, the pin head 36 constitutes the handling portion 21.

In both embodiments and independently from the door locking device 6, the door 7 comprises an automatically closing latch-notch-connection to bring the door 7 into a closed but unlocked state. To open this connection from the inner side 10, a door handle 38 is provided. On the outer side 9 a keyhole 39 is provided. The latch-notch-connection can be opened from the outer side 9 by a respective key.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A door arrangement for a wind turbine, comprising a door with an outer side and an inner side and a door locking device for locking and unlocking the closed door by coupling and decoupling the closed door with a stationary component of the door arrangement of the wind turbine, wherein the door locking device comprises a central component, an attachment and a connector, wherein the central component is attached to the stationary component by the attachment and connectable and disconnectable with the door by the connector for locking and unlocking the door by a person being at the outer side, wherein the attachment is manually releasable by a person being at the inner side for disconnecting the central component from the stationary component to unlock the door without tools.

2. The door arrangement according to claim 1, wherein the attachment comprises a handling section which the person being at the inner side can grasp by the fingers for disconnecting the central component from the stationary component, wherein the handling section is particularly a knurled knob or a star knob.

3. The door arrangement according to claim 1, wherein the central component comprises a plate and a receiving element, wherein the receiving element is attached to the plate and the plate is attached to the stationary component by the attachment, wherein the receiving element is adapted to receive the connector for connecting the central component with the door.

4. The door arrangement according to claim 3, wherein the attachment is a or comprises at least one knob stud which extends through the plate and which is manually unscrewable from a threaded hole of the stationary component for disconnecting the central component from the stationary component to manually unlock the door by the person being at the inner side.

5. The door arrangement according to claim 4, wherein the attachment is or comprises three knob studs extending through the plate and being manually unscrewable from a threaded hole of the stationary component each, wherein the three threaded holes are arranged triangularly to each other.

6. The door arrangement according to claim 3, wherein the central component and an attaching plate, which is attached to the stationary component, comprise a lug each, wherein the attachment is or comprises a pin which runs through the lugs and which are pulled out from the lugs manually for disconnecting the central component from the stationary component to manually unlock the door by the person being at the inner side.

7. The door arrangement according to claim 3, wherein the connector is a or comprises at least one threaded bolt which extends through the door and which is unscrewable from a threaded hole of the receiving element for disconnecting the central component from the door to unlock the door by the person being at the outer side.

8. The door arrangement according to claim 7, wherein the threaded bolt is unscrewable from the threaded hole of the central component with a hex wrench or a wrench comprising a nut.

9. The door arrangement according to claim 1, wherein the stationary component is a door frame.

10. A door locking device for locking and unlocking a closed door with an outer side and an inner side by coupling and decoupling the door with a stationary component, wherein the door locking device comprises a central component, an attachment and a connector, wherein the attachment is adapted to attach the central component to the stationary component, wherein the connector is adapted to connect and disconnect the central component with the door for locking and unlocking the door by a person being at the outer side, wherein the attachment comprises a handling section which allows the attachment to be manually released by a person being at the inner side for disconnecting the central component from the stationary component to unlock the door without tools.

11. The door locking device according to claim 10, wherein the attachment comprises a handling section which the person being at the inner side can grasp by the fingers for disconnecting the central component from the stationary component, wherein the handling section is particularly a knurled knob or a star knob.

12. A wind turbine, comprising at least one door arrangement according to claim 1.

13. The wind turbine according to claim 12, wherein the door arrangement constitutes an entrance door on the bottom of a tower of the wind turbine.

14. A wind turbine, comprising at least one door locking device according to claim 10.
